(19) United States
(12) Patent Application Publication
(10) Pub. No.: US 2016/0282175 A1
(43) Pub. Date: Sep. 29, 2016

(54) REMOVABLE PROTECTIVE CAP FOR AN IMAGE SENSOR

(71) Applicant: SEMICONDUCTOR COMPONENTS INDUSTRIES, LLC, Phoenix, AZ (US)

(72) Inventors: Oswald Leroy SKEETE, Phoenix, AZ (US); Martin GEIGER, Bavaria (DE); Michael R. FORBIS, Meridian, ID (US)

(73) Assignee: SEMICONDUCTOR COMPONENTS INDUSTRIES, LLC, Phoenix, AZ (US)

(21) Appl. No.: 14/667,489

(22) Filed: Mar. 24, 2015

(51) Int. Cl. G01J 1/04

(52) U.S. Cl. CPC G01J 1/0403

(57) ABSTRACT

A protective cap may be provided to protect and cover an image sensor without leaving any residue on the image sensor. The protective cap may include a cover and a number of side members. The cover may have a recess that ensures the protective cap does not directly contact the majority of the image sensor. The side members may include guiding side members that provide a flat surface to laterally restrain the image sensor. Clamping side members for holding the image sensor in place may also be included. The side members may have recessed portions for receiving the image sensor. The cover may have notches adjacent to the side members that allow the side members to flex when a bias force is applied to the side members. The side members may have guide holes that help align a tool that is used to apply the bias force.

### BACKGROUND

This relates generally to image sensors and, more particularly, to ways of protecting image sensors from damage.

Modern electronic devices such as cellular telephones, cameras, and computers often use camera modules with digital image sensors. Imagers (i.e., image sensors) often include a two-dimensional array of image sensing pixels. Each pixel typically includes a photosensitive element such as a photodiode that receives incident photons (light) and converts the photons into electrical signals.

Image sensors often include a transparent cover that covers the image sensing pixels. The cover protects the image sensing pixels from exterior contaminants such as dust and dirt. It is important that these transparent covers have no defects. Because the image sensing pixels receive light through the transparent cover, any imperfections in or on the transparent cover results in visual artifacts in the image captured by the image sensor.

Due to the sensitivity of the transparent cover, it is important to ensure that the cover is not cracked, stained, or marked in any way. An image sensor may be particularly prone to damage whenever the image sensor is moved from one location to another (e.g., delivered to an electronic device manufacturer). Typically, a protective film is used to protect image sensors. These films may be made of polyimide and are attached to a surface of the transparent cover of the image sensor. However, when the protective films are removed, adhesive residue often remains on the transparent cover of the image sensor. This residue will result in decreased performance of the image sensor and can be difficult to remove without damaging the image sensor.

It would therefore be desirable to provide improved methods and structures for protecting image sensors.

### BRIEF DESCRIPTION OF THE DRAWINGS

FIG. 1 is a cross-section side view of a conventional image sensor.

FIG. 2 is a perspective view of an illustrative protective cap in accordance with an embodiment of the present invention.

FIG. 3 is a top view of an illustrative protective cap in accordance with an embodiment of the present invention.

FIG. 4 is a cross-sectional side view of an illustrative protective cap taken along line 34 of FIG. 3 in accordance with an embodiment of the present invention.

FIG. 5 is a cross-sectional side view of an illustrative protective cap taken along line 34 of FIG. 3 in accordance with an embodiment of the present invention.

FIG. 6 is a cross-sectional side view of an illustrative protective cap taken along line 32 of FIG. 3 in accordance with an embodiment of the present invention.

FIG. 7 is a cross-sectional side view of an illustrative protective cap and an image sensor taken along line 34 of FIG. 3 in accordance with an embodiment of the present invention.

FIG. 8 is a cross-sectional side view of an illustrative protective cap receiving a bias force taken along line 34 of FIG. 3 in accordance with an embodiment of the present invention.

FIG. 9 is a flowchart of illustrative steps for installing a protective cap on an image sensor in accordance with an embodiment of the present invention.

FIG. 10 is a flowchart of illustrative steps for removing a protective cap from an image sensor in accordance with an embodiment of the present invention.

### DETAILED DESCRIPTION

Electronic devices such as digital cameras, computers, cellular telephones, and other electronic devices include image sensors that gather incoming image light to capture an image. An image sensor may include an array of imaging pixels. The imaging pixels may include photosensitive elements such as photodiodes that convert the incoming image light into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the imaging pixels and readout circuitry for reading out image signals corresponding to the electric charge generated by the photosensitive elements.

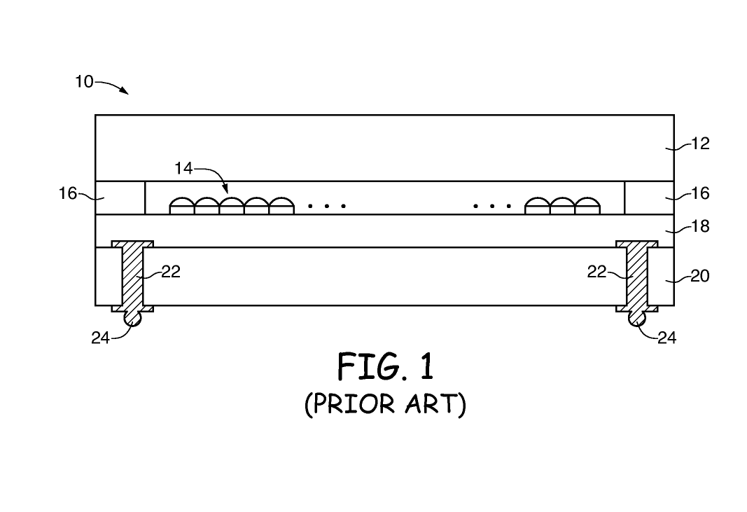

A conventional arrangement for an image sensor is shown in FIG. 1. Image sensor 10 includes an image pixel array 14 formed in a silicon substrate 18. Silicon substrate 18 is formed on a front surface of a silicon carrier 20. Through-silicon vias 22 are formed in silicon carrier 20 and are used as interconnects for connecting image sensor circuitry associated with pixel array 14 to a printed circuit board. Solder balls 24 are formed on a rear surface of silicon carrier 20 and are used to electrically connect through-silicon vias 22 to bond pads on a printed circuit board. A glass cover 12 is provided over pixel array 14 and is bonded to silicon substrate 18 using adhesive 16.

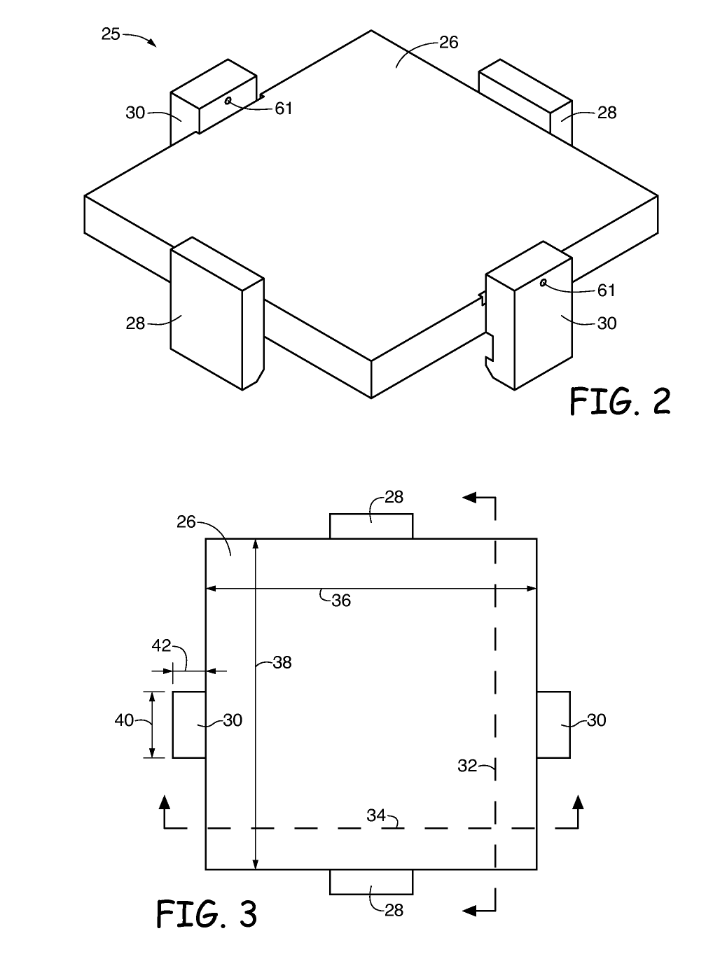

FIG. 2 is a perspective view of an illustrative protective cap for an image sensor. Protective cap 25 may be used to protect an image sensor such as image sensor 10. Protective cap 25 may be used to protect any desired type of image sensor (e.g., charge-coupled device (CCD) image sensor, complementary metal-oxide semiconductor (CMOS) image sensor, etc.) in any desired packaging arrangement. As shown, protective cap 25 (sometimes referred to herein as protective structure or structure) may include cover portion 26, guiding side members 28 (sometimes referred to herein as posts, guiding posts, or side members), and clamping side members 30 (sometimes referred to herein as posts, clamping posts, or side members). Guiding members 28 may provide a flat surface that rests adjacent to an image sensor without providing any protruding features to hold or clip the image sensor into place. Clamping side members 30 may have a recessed portion that receives the image sensor and a protruding portion that covers the image sensor and prevents the image sensor from being removed from the protective cap. Cover portion 26 may have a recessed portion so that the transparent cover of the image sensor is not in direct contact with the protective cap. Side members 28 and 30 may have guide holes 61 to assist in the placement of a bias force.

Protective structure 25 may be made from any desired material. Protective cap 25 may be made, for example, from liquid crystal polymer. When an image sensor such as image sensor 10 is installed in an electronic device, the image sensor is often soldered to a circuit board. In order to temporarily attach an image sensor to its intended circuit board, a solder reflow process may occur in which the image sensor is temporarily subjected to high temperatures such as 260° C. In certain embodiments, it may be desirable for protective cap 25 to remain attached to the image sensor during solder reflow. Thus, the protective cap 25 may be made from a material that can maintain suitable strength at the high temperatures associated with solder reflow. Additionally, protective cap 25 may be made from a material that leaves no residue on the image sensor. Using a material that does not shed any particles may help avoid unwanted residue.

FIG. 3 is a top view of an illustrative protective cap. As shown guiding posts 28 are positioned directly across from each other and clamping posts 30 are positioned directly across from each other. This example is purely illustrative. There may be, for example, multiple posts on each side of cover portion 26. Each side may have one side member, two side members, three side members, more than three side members, or any other desired number of side members. The illustrated embodiment shows the same number of side members on each side of cover 26. This example is purely illustrative. There may be, for example, two side members on a first side of cover 26 and one side member on an opposing side of cover 26. Guiding side members and clamping side members may also be combined on each side of cover 26. In one illustrative example, each side of cover 26 may have one guiding member and one clamping member. In general, the guiding side members and clamping side members may be arranged in any desired way.

Protective cap 25 may have any desired dimensions. The cover portion 26 may have a length 36 and a width 38. Cover portion 26 may have any desired length and width. In certain embodiments, the length and width of cover portion 26 may be the same. In other embodiments, the length and width of cover portion 26 may be different. FIG. 3 shows cover portion 26 as a square. However, this example is purely illustrative and cover portion 26 may have any desired shape (e.g., square, rectangle, circle, oval, etc.). The length and width of cover portion 26 may have any desired magnitude (e.g., less than 5 mm, greater than 5 mm, less than 10 mm, 10 mm, greater than 10 mm, greater than 15 mm, etc.).

Side members 28 and 30 may have a length 40 and width 42. Side members 28 and 30 may have any desired length and width. In certain embodiments, the length and width of the side members may be the same. In other embodiments, the length and width of the side members may be different. FIG. 3 shows side members 28 and 30 as rectangles. However, this example is purely illustrative and side members 28 and 30 may have any desired shape (e.g., square, rectangle, circle, oval, etc.). The length and width of side members 28 and 30 may have any desired magnitude (e.g., less than 0.5 mm, less than 2 mm, 2 mm, greater than 2 mm, greater than 5 mm, etc.).

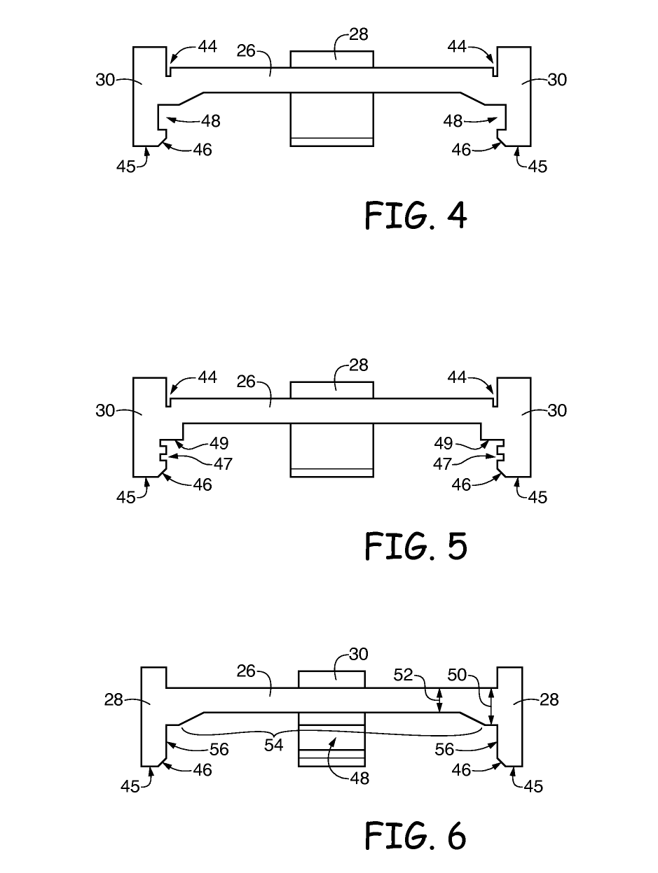

FIG. 4 is a cross-sectional side view of an illustrative protective cap taken along line 34 of FIG. 3. As shown, clamping posts 30 have features that enable the protective cap to remain secured to an image sensor. Clamping side members 30 may include sloped surface 46. This sloped surface enables the image sensor to be guided into the protective cap during placement. The sloped surface may have any desired slope relative to the bottom surface of the clamping post (e.g., surface 45). Sloped surface 46 may have a slope of less than 5°, less than 10°, less than 30°, less than 45°, 45°, greater than 45°, greater than 60°, or greater than 75° relative to bottom surface 45.

Clamping posts 30 may include recessed portion 48. Recessed portion 48 may have a height that is suitable to receive an image sensor. The recessed portion may have top and bottom surfaces that contact the top and bottom surfaces of the image sensor when the protective cap is placed on the image sensor. The side surface of recessed portion may be in contact with the image sensor when the protective cap is placed on the image sensor. Alternatively, the side surface of recessed portion may not contact the image sensor when the protective cap is placed on the image sensor.

Clamping posts 30 may also include notch 44. This notch is a small recessed portion in the top surface of cover 26 adjacent to clamping side member 30. The notch may provide increased flexibility of the side member in that region. This increased flexibility may help clamping side member flex to receive an image sensor.

FIG. 5 is a cross-sectional side view of an illustrative protective cap taken along line 34 of FIG. 3. In this embodiment, clamping posts 30 may not include recessed portion 48 shown in FIG. 4. Instead of using recessed portion 48 to receive an image sensor and at least partially surround the image sensor on all four sides (e.g., top surface, bottom surface, and both side surfaces), the clamping side members of FIG. 5 may only contact the image sensor on three sides (e.g., top surface and both side surfaces). One surface of the image sensor may not contact the protective cap at all when the image sensor is placed in the protective cap. The force applied by the clamping side members 30 to the sides of an image sensor may be sufficient to hold the image sensor in place. A surface of the image sensor may rest on holding surface 49. Clamping posts 30 may also include grooves such as groove 47. Clamping posts 30 may include one groove, two grooves, more than two grooves, or zero grooves. Grooved portions may enable the clamping side member to better grip the image sensor when the image sensor is placed in the protective cap.

The embodiments of clamping posts 30 shown in FIGS. 4 and 5 are purely illustrative. The features from these clamping posts may be used alone or in any combination. In some cases, protective cap 25 may include both clamping posts with the features shown in FIG. 4 and clamping posts with the features shown in FIG. 5. In other embodiments, protective cap 25 may include only clamping posts with the features shown in FIG. 4 or only clamping posts with the features shown in FIG. 5.

FIG. 6 is a cross-sectional side view of an illustrative protective structure taken along line 32 of FIG. 3. As shown, guiding posts 28 may include sloped surface 46. This sloped surface enables the image sensor to be guided into the protective structure during placement. The sloped surface may have any desired slope relative to the bottom surface of the guiding post (e.g., surface 45). Sloped surface 46 may have a slope of less than 5°, less than 10°, less than 30°, less than 45°, 45°, greater than 45°, greater than 60°, or greater than 75° relative to bottom surface 45. The slope of the sloped surface of each side member may be the same or the slope may vary for each side member. In one illustrative example, the guiding posts may have a sloped surface with a first slope and the clamping posts may have a sloped surface with a second, different slope. In another illustrative example, the side members all may have sloped surfaces of the same slope.

Guiding posts 28 may have a planar side surface that lacks recess 48 of clamping posts 30. Planar side surface 56 may contact the side of an image sensor when the protective cap is placed on the image sensor.

Also shown in FIG. 6 is recessed portion 54 of cover 26. As shown, cover 26 may have a first thickness 50 at the periphery of the cover. The central portion of cover 26 may have second thickness 52 that is smaller than thickness 50. This arrangement results in a recess in the center portion of cover 26. For example, in embodiments where cover 26 is a square, there may be a square recessed portion in the center of the cover 26. This recessed portion may be advantageous in avoiding marking the transparent cover (e.g., glass cover 12) of an image sensor. The image sensor may have a planar surface that is in contact with the thicker portion of cover 26 (e.g., the periphery). The central portion of the image sensor is then separated from the surface of cover 26 by the recess. In this arrangement, the image sensor may be protected from external contaminants while the majority of the transparent cover may be kept from being in direct contact with another material.

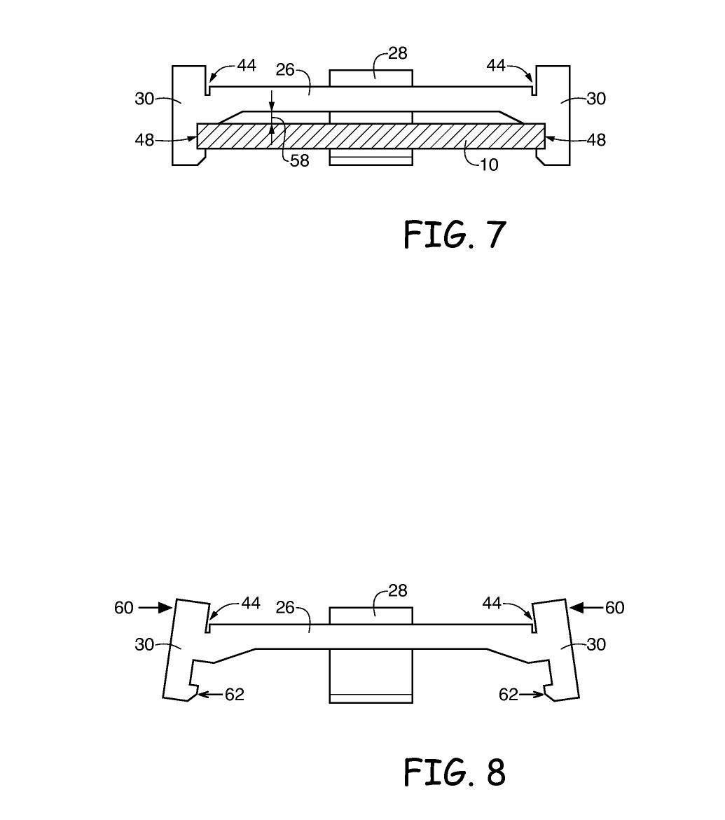

FIG. 7 is a cross-sectional side view of an illustrative protective cap and an image sensor taken along line 34 of FIG. 3. FIG. 7 shows how an image sensor can be held by the protective cap. In this illustrative example, image sensor 10 is constrained by clamping posts 30. The recessed portion 48 of clamping posts 30 prevents the image sensor from easily falling off of the protective cap. The image sensor is also separated from the bottom surface of cover 26 by distance 58. This gap (from recess 54) ensures that the top surface of image sensor is not marked or scratched by protective cap 25. The periphery of the bottom surface of cover 26 may contact the periphery of the image sensor instead of being separated from the image sensor by the gap.

FIG. 8 is a cross-sectional side view of an illustrative protective cap receiving a bias force taken along line 34 of FIG. 3. In order to place an image sensor into protective cap 25, the clamping side members 30 may be pinched together to provide room for the image sensor. As shown in FIG. 8, biasing force 60 may be applied towards the center of protective cap 25 on an upper portion of side members 30. Bias force 60 on side members 30 may result in the bottom portions of side members 30 being pushed in outward direction 62. The separation of the bottom portion of side members 30 may allow the image sensor to be removed from protective cap 25. Notch 44 provides increased flexibility for side members 30 when receiving bias force 60. The notch may allow the bottom portion of side members 30 to be separated by a greater distance, thus allowing image sensor 10 to easily be installed or removed from the protective cap.

In certain embodiments, one or more of side members 28 and 30 may include guide holes 61 (e.g., holes 61 in FIG. 2). These holes may pass from one side of the side member to the other through the side member. The hole may be positioned on an upper portion of the side member (e.g., above cover 26). The hole may provide a guide for applying bias force 60. For example, tweezers or another desired tool may be used to apply bias force 60 and remove protective cap 25 from an image sensor. The holes may provide a target that guides the tweezers into the proper location for applying bias force 60. The tweezers may have protruding members that protrude into holes 61. When the tweezers are squeezed the clamping side members may release the image sensor or allow the image sensor to easily be placed in the cap.

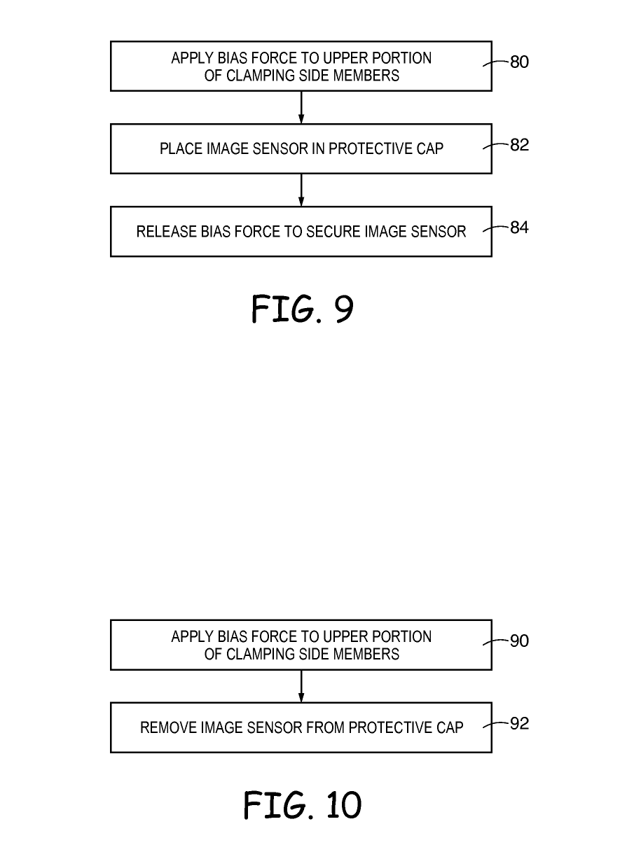

FIG. 9 is a flowchart of illustrative steps for installing a protective cap on an image sensor. At step 80, a bias force may be applied to one or more side members of the protective cap. Applying the bias force may provide extra room for the image sensor to be installed in the protective cap. In some cases, the bias force may be applied with the assistance of guide holes 61. At step 82, the image sensor may be placed in the protective cap. Sloped surfaces of the side members (e.g., sloped surfaces 46) may help guide the image sensor into the correct location within the protective cap. In certain embodiments, step 80 may be omitted and the image sensor may be placed into the protective cap without applying the bias force. In embodiments where a bias force is applied, the bias force may be released at step 84. Releasing the bias force may return the clamping side members to their original position. The clamping side members may surround and withhold the image sensor to prevent the image sensor from falling off of the protective cap.

FIG. 10 is a flowchart of illustrative steps for removing a protective cap from an image sensor. At step 90, a bias force may be applied to the upper portion of clamping side members 30. In some cases, the bias force may be applied with the assistance of guide holes 61. The bias force may enable the image sensor to be removed from the protective cap at step 92. In certain embodiments, the image sensor may be removed from the protective cap without applying the bias force.

Various embodiments have been described methods and structures of protecting an image sensor. In various embodiments, a protective cap may include a cover with first and second opposing sides connected by third and fourth opposing sides. The protective cap may also include a first side member on the first side of the cover and a second side member on the second side of the cover. The first and second side members may be configured to secure an image sensor. The protective cap may have a length, width, and a height that are each less than fifty millimeters. The protective cap may have a third side member on the third side of the cover and a fourth side member on the fourth side of the cover. The first and second side members may each have a respective recess that is configured to receive the image sensor. The third and fourth side members may each have a planar surface that is adjacent to and substantially perpendicular to a bottom surface of the cover. The third and fourth side members may each have a surface that is adjacent to eth respective planar surface and sloped with respect to the respective planar surface.

The protective cap may have a first region at a periphery of the cover and a second region at a center of the cover. The first and regions may have respective first and second thicknesses, with the first thickness being greater than the second thickness. The second region may form a recess on the bottom surface of the cover. The first and second side members each may include upper portions with guide holes. The cover may have a top surface with at least one notch. The cover may have a first notch directly adjacent to the first side member and a second notch directly adjacent to the second side member.

In various embodiments, an assembly may include an image sensor and a structure. The image sensor may include a transparent cover. The structure may include a cover and a plurality of side members adjacent to the cover. The structure may be configured to cover the transparent cover of the image sensor. The majority of an outermost surface of the transparent cover may be separated from the structure by a gap. The image sensor may be interposed between the cover of the structure and a portion of at least one of the side members.

The plurality of side members may include first and second side members positioned at respective first and second opposing sides of the cover and third and fourth side members positioned at respective third and fourth opposing sides of the cover. The image sensor may be interposed between the cover of the structure and a portion of only the first and second side members. The side members may each have a sloped surface that is angled towards a bottom surface of the image sensor. The first and second side members may each include a respective guide hole.

In various embodiments, a method may include applying a bias force to first and second side members of a protective structure and placing an image sensor in the protective structure. Placing the image sensor in the protective structure may include placing first and second opposing sides of the image sensor into respective first and second recesses of the first and second side members.

Applying the bias force may include biasing an upper portion of the first and second side members towards a center of the protective structure. The respective first and second recesses of the first and second side members may each be on a respective lower portion of the first and second side members. The first and second side members may include respective first and second holes. Applying the bias force may include aligning first and second protruding portions of a tool such that the first and second protruding portions protrude into the respective first and second holes.

The foregoing is merely illustrative of the principles of this invention and various modifications can be made by those skilled in the art. The foregoing embodiments may be implemented individually or in any combination.

What is claimed is:

1. A protective cap comprising:
a cover with first and second opposing sides connected by third and fourth opposing sides; and
a first side member on the first side of the cover and a second side member on the second side of the cover, wherein the first and second side members are configured to secure an image sensor.

2. The protective cap of claim 1, wherein the protective cap has a length, a width, and a height, and wherein the length, width, and height are each less than fifty millimeters.

3. The protective cap of claim 1, further comprising:
a third side member on the third side of the cover and a fourth side member on the fourth side of the cover.

4. The protective cap of claim 3, wherein the first and second side members each have a respective recess that is configured to receive the image sensor.

5. The protective cap of claim 4, wherein the third and fourth side members each have a planar surface that is adjacent to and substantially perpendicular to a bottom surface of the cover.

6. The protective cap of claim 5, wherein the third and fourth side members each have a surface that is adjacent to the respective planar surface and sloped with respect to the respective planar surface.

7. The protective cap of claim 1, wherein the cover has a first region at a periphery of the cover, wherein the cover has a second region at a center of the cover, wherein the first and second regions have respective first and second thicknesses, and wherein the first thickness is greater than the second thickness.

8. The protective cap of claim 7, wherein the second region forms a recess on a bottom surface of the cover.

9. The protective cap of claim 1, wherein the first and second side members each comprise respective upper portions, and wherein each respective upper portion has a respective guide hole.

10. The protective cap of claim 1, wherein the cover has a top surface, and wherein the top surface has at least one notch.

11. The protective cap of claim 10, wherein the at least one notch comprises a first notch that is directly adjacent to the first side member and a second notch that is directly adjacent to the second side member.

12. An assembly comprising:
an image sensor comprising a transparent cover; and
a structure comprising a cover and a plurality of side members adjacent to the cover, wherein the structure is configured to cover the transparent cover of the image sensor, wherein a majority of an outer-most surface of the transparent cover is separated from the structure by a gap, and wherein the image sensor is interposed between the cover of the structure and a portion of at least one of the side members.

13. The assembly defined in claim 12, wherein the plurality of side members comprises first and second side members positioned at respective first and second opposing sides of the cover and third and fourth side members positioned at respective third and fourth opposing sides of the cover.

14. The assembly defined in claim 13, wherein the image sensor is interposed between the cover of the structure and a portion of only the first and second the side members.

15. The assembly defined in claim 14, wherein the first, second, third, and fourth side members each have a sloped surface that is angled towards a bottom surface of the image sensor.

16. The assembly defined in claim 15, wherein the first and second side members each comprise a respective guide hole.

17. A method comprising:
applying a bias force to first and second side members of a protective structure; and
placing an image sensor in the protective structure, wherein placing the image sensor in the protective structure comprises placing first and second opposing sides of the image sensor into respective first and second recesses of the first and second side members.

18. The method defined in claim 17, wherein applying the bias force comprises biasing an upper portion of the first and second side members towards a center of the protective structure.

19. The method defined in claim 18, wherein the respective first and second recesses of the first and second side members are each on a respective lower portion of the first and second side members.

20. The method defined in claim 17, wherein the first and second side members have respective first and second holes, and wherein applying the bias force comprises aligning first and second protruding portions of a tool such that the first and second protruding portions protrude into the respective first and second holes.
